(19) United States
(12) Patent Application Publication
(10) Pub. No.: US 2026/0311695 A1
(43) Pub. Date: Oct. 8, 2026

(54) EARBUD-ENHANCED CONVERSATIONAL AI WITH AMBIENT AWARENESS

(71) Applicant: GOOGLE LLC, Mountain View, CA (US)

(72) Inventor: Shahabuddin Kakargola, Costa Mesa, CA (US)

(21) Appl. No.: 19/173,464

(22) Filed: Apr. 8, 2025

(51) Int. Cl. G10L 15/22

(52) U.S. Cl. CPC G10L 15/22; G10L 2015/223

(57) ABSTRACT

Implementations relate to one or more electronic devices configured to identify a first data related to a user’s voice recording from earbuds and a second data from an ambient recording excluding the user’s voice. Based on these, a third data can be generated concerning a portion of the ambient recording. The third data can be stored for later use with a conversational AI assistant. Some implementations can distinguish the user's voice from other voices in the environment. Some implementations can allow users to continue discussions with the AI across multiple sessions and review previous discussions. Other implementations can be described and/or claimed.

### BACKGROUND

The use of personal digital assistants has increased in recent years. These assistants can be used to provide answers to specific questions and perform simple tasks. Such personal digital assistants, however, can lack the ability to engage in complex discussions or natural conversations. Conversational artificial intelligence (AI) can offer the potential for more productive and creative interactions, including brainstorming and simplifying intricate topics. The integration of these conversational AI technologies with hearable devices, such as earbuds, has historically focused on capturing input from the user wearing the devices. This approach can limit the system's ability to understand and assist with external conversations and environmental contexts.

Legacy technologies can struggle to effectively process and utilize audio data captured from external sources. Phone-based recording solutions may not be configured to distinguish between the user's voice and the voices of others in the surrounding environment. This lack of distinction can make it difficult to build a comprehensive understanding of the interactions and the context in which they occur. Furthermore, legacy systems can lack the capability to seamlessly continue discussions with the AI assistant across multiple sessions, hindering the user's ability to build upon previously established context.

Some implementations herein are directed to a technique that includes identifying a first data related to a voice recording of a user's voice captured by one or more earbuds worn by the user. The technique can further include identifying a second data related to a first portion of an ambient recording captured by the one or more earbuds in a location of the user, with the first portion of the ambient recording excluding the user's voice. The technique can further include generating, based on the first data and the second data, a third data related to a second portion of the ambient recording captured in the location of the user, the second portion of the ambient recording being less than all of the first portion is also included. In some cases, the third data relates to the voice of another person captured by the earbuds in the location of the user. For example, if the user is in a meeting, the third data could be the isolated voice of a colleague.

Implementations disclosed herein can reduce or eliminate at least some of the above-described drawbacks with current techniques. For example, the ability of the earbud to capture and process external sounds and voices, and then send the processed data to the host device, can address the limitations of phone-based recording solutions that fail to distinguish between the user's voice and external voices. As another example, the companion application's capability to maintain multiple recordings can enable users to continue discussions with the AI assistant across multiple sessions, building upon previous context and avoiding the need to restart conversations from the beginning. As another example, the audio processing in the earbuds can separate the user's voice from external voices, and remove noise from not only the recording of the user's voice, but also the voice of another person that is in the location of the user, which is not something that legacy solutions can do effectively in a live conference environment.

For the sake of discussion and brevity herein, this disclosure can use some or all of the following terms. These terms are provided for the sake of discussion only, and are not intended to limit any particular implementation to a particular type of data and/or device. Specifically, implementations can be described with respect to the term "earbuds." Earbuds, as used herein, can refer to one or more listening devices that can include one or more speakers, one or more microphones, and/or audio processing circuitry. In some implementations, the listening devices can be or include one or more of an in-ear listening device, an over-ear listening device, and a listening device that covers the ear. Such listening devices can be coupled with one another via one or more physical (e.g., a connecting band between two earbuds), a wired (e.g., a signal wire that is coupled with circuitry of two or more earbuds) and/or wireless connections (e.g., a short-range wireless protocol such as Bluetooth). However, some implementations can involve only a single earbud, such as may be present in only one ear of the user. For the sake of clarity, the generalized term "earbuds" will be used to encompass one earbud, two earbuds, or more than two earbuds.

The earbuds can be communicatively coupled, via one or both of a wired and wireless connection, with a companion device. For example, the earbuds can be communicatively coupled with the companion device via a wireless protocol such as Bluetooth, Wi-Fi, a cellular protocol, and/or some other protocol. A companion device can be or include, for example, a laptop, a personal digital assistant (PDA), a smart phone, a tablet, and/or some other type of electronic device. The companion device can be configured to run one or more applications, which can be referred to as a "companion application" that can allow a user to interface with an artificial intelligence (AI) assistant. Such interfacing can take the form of, for example, inputting data to the AI assistant via a keyboard, a touchscreen, a verbal command, or some other input. The companion device can then provide one or more responses to the user via an audio output (e.g., a speaker), some form of haptic feedback, a visual output such as a display, etc.

The AI assistant can be coupled with a generative model (GM), which can be implemented by one or more processors that are a part of the companion device or separate from, but communicatively coupled with, the companion device. As described herein, a GM can refer to a machine learning model capable of generating generative vision data, generative audio data, generative textual data, and/or other forms of generative data. Some non-limiting examples of machine learning models that are capable of generating one or more forms of the generative data noted above include transformer-based machine learning models (e.g., encoder-decoder transformer models, encoder-only transformer models, decoder-only transformer models, etc. that optionally employ an attention mechanism or some other form of memory), stable diffusion-based machine learning models, recurrent neural network-based machine learning models, generative adversarial network-based machine learning models, sequence-to-sequence machine learning models, etc. Various machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.).

It will be understood that implementations herein can be described with respect to a vision language model (VLM). As used herein, a VLM can refer to a type of GM that is capable of accepting inputs in a variety of modalities such as text-based inputs and vision-based inputs. In implementations, the text-based inputs can be based on inputs that are typed by a user into the phone via a keyboard that is presented to the user on the screen of the phone, wirelessly coupled with the phone, coupled with the phone by a wired connection, etc. In other implementations, the text-based inputs can be based on or related to a transcription of an audio input by the user (e.g., via a speech-to-text program). In these implementations, the text-based input can be in a user- readable form or in some type of machine language or non-user readable form. Based on the input, the VLM can generate and/or provide an in one or more modalities including a text-based output, a visual output, an audio output, and/or some other type of output.

An "ambient recording" can include or relate to an audio recording of a location in which the earbuds are located. The ambient recording can include audio related to, for example, the user's voice, the voice of other people in the same location, and/or background "noise" such as that which can be produced by a fan, traffic, a radiator, etc. Data related to the ambient recording (which can also be referred to as "ambient data" or "ambient recording data"), such as that which can be sent from the earbuds to the companion device, can include some or all of the ambient recording (e.g., frequency-domain data), digital data related to the ambient recording (e.g., time-domain data), data related to a human or machine-readable transcription of the ambient recording, etc. In some implementations, the data related to the ambient recording can be based on the raw audio ambient recording where different sound levels or tones are not adjusted. In other implementations, the data related to the ambient recording can be based on processed audio where sound levels or tones are adjusted by the earbuds to, for example, remove background noise from the ambient recording.

A "voice recording" can include or relate to an audio recording that primarily includes the voice of the user of the earbuds. In some implementations, the voice recording can be based on an audio recording by the earbuds that is different than the ambient recording. In other implementations, the voice recording can additionally or alternatively be based on processing of the ambient recording to, for example, extract audio or digital data related to the user's voice. Data related to the voice recording (which can also be referred to as "voice data" or "voice recording data"), such as that which can be sent from the earbuds to the companion device, can include some or all of the voice recording (e.g., frequency-domain data), digital data related to the voice recording (e.g., time-domain data), data related to a human or machine-readable transcription of the ambient recording, etc. In some implementations, the data related to the voice recording can be based on the raw audio voice recording, where different sound levels or tones are not adjusted. In other implementations, the data related to the voice recording can be based on processed audio where sound levels or tones are adjusted by the earbuds to, for example, remove background noise from the voice recording (i.e., to isolate the user's voice). In some implementations where the earbuds do not capture a separate voice recording, the earbuds can generate the voice recording based on the ambient recording. In other implementations, the companion device can additionally or alternatively generate the voice recording based on the data related to the ambient recording.

A "recording session" can include or relate to one or more points in time at which an audio recording such as a voice recording and/or ambient recording can be recorded. In some implementations, the recording session can relate to a single audio recording such that it starts when the audio recording starts and stops when the audio recording stops. In other implementations, the recording session can relate to a plurality of audio recordings at a single location or plurality of locations. For example, consider a user that starts a recording session that includes both a voice recording and an ambient recording. During the recording, the user receives a phone call that interrupts the recording session. When the phone call is over, the recording session can resume until such time as the recording session ends (e.g., by a user stopping the recording session). In this situation, the recordings before and after the phone call can be considered, in some implementations, as parts of a single recording session.

A "query session" can include or relate to one or more strings of queries provided by the user and/or strings of responses to those queries provided by an AI assistant. Generally, a query session can be conducted over a mostly coherent and uninterrupted time span, as may be similar to the time span of a natural language conversation between two people. In some implementations, two or more query sessions can relate to a single recording session. For example, the user can conduct a first query session related to a recording session. In this query session, the user can provide one or more queries related to a recording session. The AI assistant can provide one or more responses to those queries. Later, for example the next day, the user can think of an additional question related to the recording session. If the user provides this query to the system, then such provision may relate to a second query session that is still related to the same recording session.

As a non-limiting example of some implementations disclosed herein, consider a student attending a university lecture. The student, wearing a pair of earbuds, can initiate a recording session. Initiation of the recording session can be done by, for example, utterance of an initiating verbal phrase or other sound, pressing a button on the earbuds, pressing a button on the mobile phone to which the earbuds are communicatively coupled, etc. In some implementations, upon activation, the application can instruct the earbuds to enter a "transparency" mode, allowing the student to clearly hear the professor's lecture and any questions or comments from other students in the classroom. Such an instruction may be desirable if the earbuds are initially in an active noise cancellation (ANC) mode that blocks at least a part of the noise in the location of the student. The earbuds can also begin capturing an ambient recording and a voice recording. In other implementations, the earbuds can additionally or alternatively begin capturing the ambient recording and generating the voice recording based on the ambient recording/data. The earbuds can then transmit at least a portion of the ambient data to the mobile phone. Additionally or alternatively, the earbuds can transmit at least a portion of the voice data to the mobile phone. In some implementations, the voice data can be transmitted as part of a same data stream as the ambient data (e.g., the voice and ambient data can be multiplexed). In other implementations, the audio and voice data can be transmitted separately from one another (e.g., using different time and/or frequency resources).

Throughout the lecture, the mobile phone can store some or all of the ambient and/or voice data locally. In some implementations, the mobile phone can generate specific audio data related to another student and/or the professor. For example, the mobile phone can use the voice data to remove the user's voice from the ambient data. The mobile phone can also remove noise from the ambient data to isolate one or more other voices. In some implementations, as described below, the mobile phone can be configured to then isolate the one or more other voices from one another to generate separate data for at least one of the other voices at the lecture. In some implementations, the mobile phone can do this in near-real time such that it is processing the data while other data is still being recorded and/or transmitted to the mobile phone. In some implementations, the mobile phone can additionally or alternatively perform the data processing after it has received all of the voice and/or ambient data for the lecture.

At the end of the lecture, the student can trigger the recording session to end, which can signal the companion application to cease recording and, optionally, can instruct the earbuds to revert to their previous audio mode (e.g., active noise cancellation). Later that evening, while reviewing notes, the student can invoke an AI model and initiate a conversation about the recorded lecture. The AI assistant can then provide a summary of the key topics discussed, clarify complex concepts, and even identify potential areas for further research, all based on the processed ambient and/or voice data captured during the lecture. Specifically, because the audio data has been processed to isolate different voices, the AI assistant can be configured to provide summaries of the different viewpoints of the people present, the points they made respectively, the questions that a certain person asked, etc. Furthermore, if the student gets interrupted during the review session, they can later resume the discussion with the AI assistant, picking up precisely where they left off, with the AI assistant retaining the context of their previous interactions.

As another non-limiting example of some implementations disclosed herein, consider a person attending a social gathering or party. Upon arrival, the individual may initiate a recording session as described above. Throughout the party, the earbuds can discreetly capture one or both of an ambient recording and a voice recording from the surrounding environment and/or directly from the user. For instance, during a conversation with a friend about a recent movie, the earbuds can record audio that includes the user's remarks, the friend's opinions and reactions, and/or background music and other ambient sounds. Some or all of the related audio and/or voice data can then be transmitted to, and stored on, the user's mobile phone, which is stored in their pocket and running a companion application. As described above, in some implementations, the mobile phone can be configured to isolate data related to the voice of the friend. Later, perhaps the next day, while reflecting on the party, the user can engage in a discussion with the AI assistant regarding specific details about the movie discussed, and the other person's perspective on the movie, etc., all based on the audio data captured by the earbuds during the party. If the user gets distracted and cannot continue the discussion, they can later resume the conversation, with the AI assistant retaining the context of their previous inquiries. This can allow the user to gain a deeper understanding of the social dynamics and discussions that occurred at the gathering, enhancing their social awareness and memory.

The preceding is presented as an overview of only some implementations disclosed herein. These and other implementations are disclosed in additional detail herein.

### BRIEF DESCRIPTION OF THE DRAWINGS

FIG. 1 illustrates an example computing environment, in accordance with various implementations.

FIG. 2a depicts initiation of a recording session based on a user providing a verbal cue, in accordance with various implementations.

FIG. 2b depicts cessation of a recording session responsive to a verbal cue from a user, in accordance with various implementations.

FIG. 3 depicts an example process, in accordance with various implementations.

FIG. 4 depicts an alternative example process, in accordance with various implementations.

FIG. 5 depicts an example computing device, in accordance with various implementations.

### DETAILED DESCRIPTION

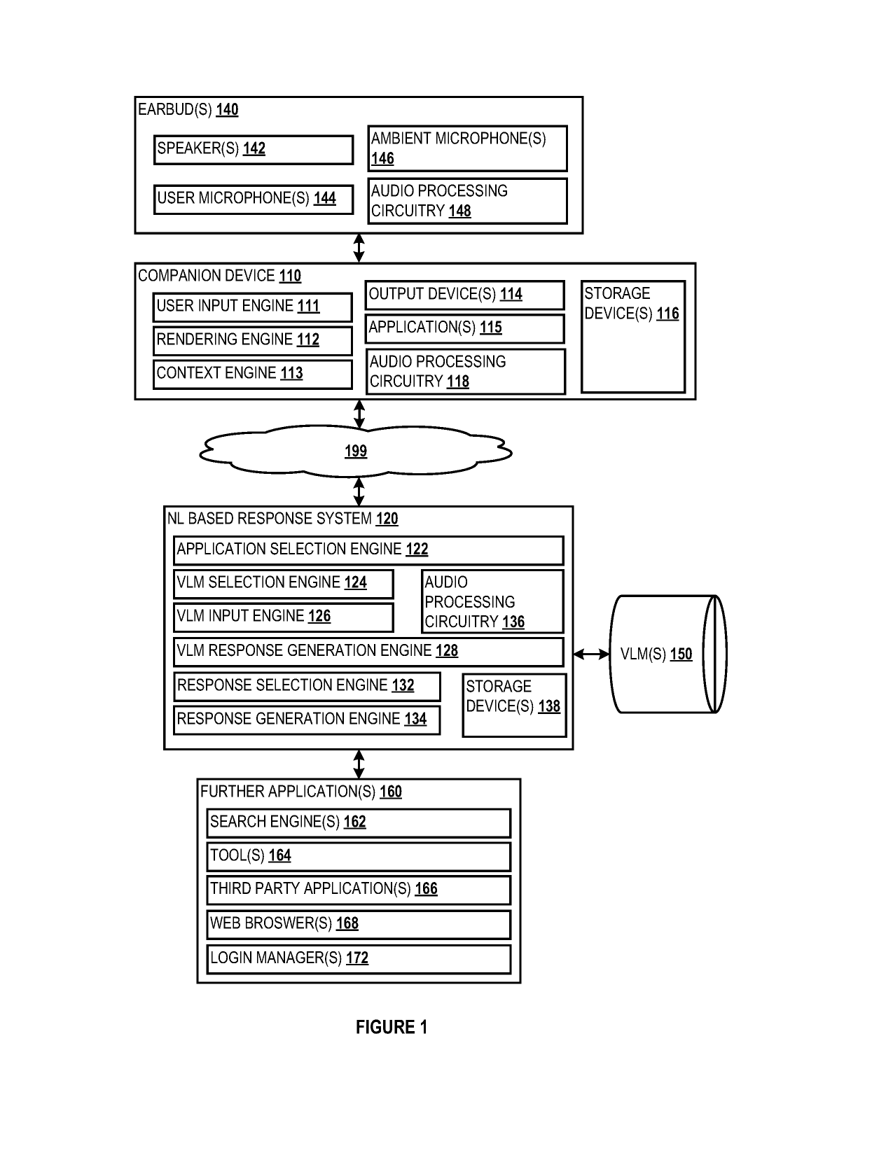

Turning now to FIG. 1, a block diagram of an example environment that demonstrates various aspects of the present disclosure, and in which implementations disclosed herein can be implemented, is depicted. The example environment can include a companion device 110, a natural language (NL) response system 120, and one or more further applications 160 (e.g., applications external to a VLM or a dialogue application executed on the companion device 110). As shown, the companion device 110 can be coupled with one or more earbud(s) 140. Although illustrated separately, in some implementations, all or aspects of the NL based response system 120 and all or aspects of the one or more further applications 160 can be implemented as part of a cohesive system. Similarly, in some implementations, all or aspects of the companion device 110 and the earbud(s) 140 can be implemented as part of a unitary physical device (e.g., the earbud(s) 140 can be part of the companion device 110 or vice-versa).

In some implementations, all or aspects of the NL based response system 120 can be implemented locally at the companion device 110. In additional or alternative implementations, all or aspects of the NL based response system 120 can be implemented remotely from the companion device 110 as depicted in FIG. 1 (e.g., at one or more remote server(s)). In those implementations, the companion device 110 and the NL based response system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet, one or more cellular networks, one or more satellite-based networks, etc.).

The companion device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker having a display, a smart appliance such as a smart television or smart refrigerator, and/or a wearable apparatus of the user that includes a computing device (e.g., a watch of the user having a computing device, glasses of the user having a computing device, a virtual or augmented reality computing device, etc.). Additional and/or alternative companion devices can be provided.

The companion device 110 can execute one or more applications, such as application(s) 115, via which queries can be submitted and/or response(s) to the query can be rendered (e.g., audibly and/or visually). The application(s) 115 can be an application that is separate from an operating system of the companion device 110 (e.g., one installed “on top” of the operating system) – or can alternatively be implemented directly by the operating system of the companion device 110. For example, the application(s) 115 can be a web browser installed on top of the operating system (OS), or can be an application that is integrated as part of the operating system functionality. The application(s) 115 can interact with the NL based response system 120.

In various implementations, the companion device 110 can include a user input engine 111 that is configured to detect user input provided by a user of the companion device 110 using one or more user interface input devices. For example, the companion device 110 can be equipped with one or more microphones that capture audio data, such as audio data corresponding to spoken utterances of the user or other sounds in an environment of the companion device 110. Additionally, or alternatively, the companion device 110 can be equipped with one or more vision components that are configured to capture vision data corresponding to images and/or movements (e.g., gestures) detected in a field of view of one or more of the vision components. Additionally, or alternatively, the companion device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the companion device 110. Some instances of a query described herein can be a query that is formulated based on user input provided by a user of the companion device 110 and detected via user input engine 111. For example, the query can be a typed query that is typed via a physical or virtual keyboard, a suggested query that is selected via a touch screen or a mouse, a spoken voice query that is detected via microphone(s) of the companion device, or an image query that is based on an image captured by a vision component of the companion device.

In various implementations, the companion device 110 can include a rendering engine 112 that is configured to provide content (e.g., an NL based summary) for audible and/or visual presentation to a user of the companion device 110 using one or more output devices 114. For example, the output device(s) 114 can be or include one or more speakers that enable content to be provided for audible presentation to the user via the companion device 110. Additionally or alternatively, the output device(s) 114 can be or include one or more monitors or screens on which one or more visual elements can be displayed. Additionally or alternatively, the output device(s) 114 can be or include an alternative type of output device such as a haptic feedback device. Generally, the rendering engine 112 can be configured to receive digital content and facilitate changing the digital content to a user-recognizable format (e.g., sound, one or more visual elements, etc.)

In various implementations, the companion device 110 can include a context engine 113 that is configured to determine a context (e.g., current or recent context) of the companion device 110 and/or of a user of the companion device 110. In some of those implementations, the context engine 113 can determine a context utilizing current or recent interaction(s) via the companion device 110, a location of the companion device 110, profile data of a profile of a user of the companion device 110 (e.g., an active user when multiple profiles are associated with the companion device 110), and/or other data accessible to the context engine 113. For example, the context engine 113 can determine a current context based on a current state of a query session (e.g., considering one or more recent queries of the query session), profile data, and/or a current location of the companion device 110. As an example, the context engine 113 can determine a current context based on which application is active in the foreground of the companion device 110, a current or recent state of the active application, and/or content currently or recently rendered by the active application. A context determined by the context engine 113 can be utilized, for example, in supplementing or rewriting a query that is formulated based on user input, in generating an implied query (e.g., a query formulated independent of user input), and/or in determining to submit an implied query and/or to render result(s) (e.g., an NL based summary) for an implied query.

In some implementations, the context can be based on one or more previous query sessions that are related to a same or similar topic. As a specific example, in some implementations the user can participate or initiate in one or more query sessions related to a given topic. Using one of the examples above, the student may participate in a query session related to a lecture that they attended. At a later time, the user may think of one or more additional questions based on the lecture. The user can then initiate an additional query session and ask new questions of the AI assistant. In this situation, the context engine 113 can use the previous query session as part of the current context.

The companion device 110 can additionally include one or more storage devices 116. In various implementations, the storage device(s) 116 can be implemented as memory such as non-volatile memory (NVM) like flash memory, a hard disk drive (HDD), read-only memory (ROM), etc. In some implementations, the UI state database(s) 116 can be additionally or alternatively implemented as volatile memory such as cache memory, random access memory (RAM), etc.

Further, the companion device 110 and/or the NL based response system 120 can include one or more memories for storage of data and/or software applications, one or more processors for accessing data and executing the software applications, and/or other components that facilitate communication over one or more of the networks 199. In some implementations, one or more of the software applications can be installed locally at the companion device 110, whereas in other implementations one or more of the software applications can be hosted remotely (e.g., by one or more servers) and can be accessible by the companion device 110 over one or more of the networks 199.

Although aspects of FIG. 1 are illustrated or described with respect to a single companion device having a single user, it should be understood that such description is for the sake of example and is not meant to be limiting. For example, one or more additional companion devices of a user and/or of additional user(s) can also implement the techniques described herein. For instance, the companion device 110, the one or more additional companion devices, and/or any other computing devices of a user can form an ecosystem of devices that can employ techniques described herein. These additional companion devices and/or computing devices can be in communication with the companion device 110 (e.g., over the network(s) 199). As another example, a given companion device can be utilized by multiple users in a shared setting (e.g., a group of users, a household).

The NL based response system is illustrated as including an application selection engine 122, a VLM selection engine 124, a VLM input engine 126, a VLM response generation engine 128, a response selection engine 132, a response generation engine 134, audio processing circuitry 136, and one or more storage devices 138. It will be understood that, in various implementations, various of the engines and/or components can be omitted, combined, or otherwise from the configuration depicted. For example, in some implementations, the engines of the NL based response system 120 can be distributed across one or more computing systems. In general, NL based response system 120 can be configured to receive a natural language query via the companion device 110, and to process the natural language query to generate a response to the natural language query via one or more further applications 160.

The application selection engine 122 can, in response to receiving a query, determine one or more further applications 160 to invoke. The application selection engine 122 can select applications that are relevant to the query, e.g., determine that the input query is directed towards subject matter within the domain of one or more further applications 160, and select/invoke one or more of the further applications 160 in response. For example, if the input query involves utilization of a webpage, then the application selection engine 122 can select a web browser application as one or more of the further application 160 to then access the webpage. It should be understood that the specifically depicted applications of FIG. 1 are depicted for the sake of example only, and the one or more further applications 160 can include any application that is accessible at the companion device 110 and/or the NL based response system 120.

The VLM selection engine 124 can, in response to receiving a query, determine which, if any, of multiple generative model(s) (VLM(s) 150 and/or other multi-modal generative model(s)) to utilize in generating response(s) to the user query. For example, the VLM selection engine 124 can select none, one, or multiple generative model(s) to utilize in generating response(s) in furtherance of the task indicated by the user query. The VLM selection engine 124 can optionally utilize one or more classifiers and/or rules (not illustrated).

The VLM input engine 126 can, in response to receiving a query, generate VLM input that is to be processed using a VLM in generating response(s) to the query. As described herein, such VLM input can include query content that is based on the query and/or additional content, such as contextual information derived from the context engine 113. In some implementations, the additional content can include data related to one or more audio recordings such as a voice recording and/or an ambient recording as described in greater detail below. In some implementations, the additional content can include data related to a plurality of voice recordings such as a recording of the user's voice and a recording of a voice of another person. In some implementations, the additional content can include additional contextual information such as data related to one or more previous queries of the user and/or responses by the system 120 in a previous query session.

The VLM response generation engine 128 can process VLM input that is generated by the VLM input engine 126, using a VLM, to generate output data indicating a response to the user's query. The output data, for example, can include data indicating an action type (e.g., a click, a text entry, etc.) and an indication of an interactable element in a given screen at which to perform the action. In some implementations, the output data can be or include one or more elements that include information that is to be provided to the user (e.g., by rendering engine 112 and/or output device(s) 114). The VLM response generation engine 128 can utilize one or more VLMs 150.

The response selection engine 132 can select one or more responses from, for example, the set of candidate responses output by the VLM response generation engine 128. The response selection engine 132 can, in some examples, select the candidate response with the highest confidence score for performance by the user device 110. In some examples, the response selection engine 132 can compare the confidence scores of the candidate responses to a threshold score. The selected response can be selected from the set of candidate responses with a confidence score that exceeds the threshold score. If no candidate response has a confidence score that exceeds the threshold score, the response selection engine 132 can select a default response, e.g., a response that outputs a request for further information via the companion device 110.

The response generation engine 134 can convert the response selected by the response section engine 132 into one or more commands for an application that, when implemented by an application on the companion device, 110, or by one or more further applications 160 cause the application to perform the action that is related to the response (e.g., interaction with an element depicted by an output device 114, providing information to the user, etc.).

The NL based response system 120 can further include one or more storage devices 138. The one or more storage devices 138 can be similar to, and share one or more characteristics with, the one or more storage devices 116. In some implementations, for example implementations where the NL based response system 120 and the companion device 110 are implemented as a unitary unit (e.g., a smart phone or tablet or some other similar device), the one or more storage devices 116 and 138 can be the same storage device (e.g., a single storage device with no redundancy) or there can be two or more distinct storage devices or types of storage devices.

The one or more further applications 160 is illustrated as including one or more search engines 162, one or more tools 164, one or more third-party applications 164, one or more web browsers 166 and/or one or more login managers 170. Some of the engines can be omitted in various implementations. Further applications can also be included in the one or more further applications 160, such as one or more first party applications and/or other applications. The one or more further applications 160 can be executed on a virtual machine, e.g., in a secure virtual environment, such as in a secure environment in the cloud or locally on the companion device 110.

The one or more search engines 162 can receive a search request from the NL based response system 120 and/or companion device 110 and perform a search operation on a search space. The one or more search engines 162 can return one or more search results to the NL based response system 120 and/or the companion device 110. The one or more search engines 162 can include an internet search engine.

The one or more tools 164 include, for example, applications that can be used to perform creative tasks, such as one or more image tools for creating and/or editing images, one or more document tools for reading, writing and/or editing documents, one or more audio tools for listening to, creating and/or editing audio. Many other examples are possible and are also contemplated herein.

The one or more third party applications 166 can include applications that are hosted and/or controlled by a third party for providing access to services that they provide. Examples of such third party applications include, but are not limited to: booking applications; e-commerce applications; translation applications; utility provider applications; calendar/diary applications; and/or the like.

The one or more web browsers 168 are applications that provide access to internet webpages.

The one or more login managers 170 can securely store login credentials (e.g., login names, passwords, etc.) of a user for respective application and/or webpages. The login manager can automatically input relevant login details to an application when it is accessed and/or to a webpage when it is loaded. However, it should be noted that the NL based response system 120 can ensure that any login credentials are not included in any VLM input, but the response selection engine 132 and/or the response generation engine 134 can cause any needed login credentials to be utilized.

The companion device 110 can be coupled with earbud(s) 140 via a wired or wireless connection, as previously described. In some implementations for example, smart glasses, the companion device 110 and the earbud(s) 140 can be elements of a unitary physical device. In other implementations, for example if the earbud(s) 140 are wireless in-ear earbuds and the companion device 110 is a smartphone to which the earbuds are coupled, the companion device 110 and the earbud(s) 140 can be separate from one another. The earbud(s) 140 can include one or more speakers 142, one or more user microphones 144, and one or more ambient microphones 146. The speaker(s) 142 can provide audio output to the user. Generally, the user microphone(s) 144 can be configured to capture the user's voice, generating a voice recording. The ambient microphone(s) 146 can capture audio from the user's surrounding environment, generating an ambient recording.

More specifically, in some implementations, the user microphone(s) 144 can focus on capturing the user's voice while minimizing external sounds. For example, the user microphone(s) 144 can be or include narrow-field directional microphones that are aimed at the wearer of the earbud(s) 140. The ambient microphone(s) 146 can capture a broader range of sounds from the environment, including other voices and background noise. In some implementations, the user microphone(s) 144 may not be present, and the ambient microphone(s) 146 can capture a single audio recording of the user's environment, which captures both the user's voice as well as other sounds at the location of the user such as the voices of other people, background noise, etc.

Audio processing circuitry 148 (which can also be referred to in some implementations as "digital signal processing" or "DSP" circuitry) can be configured to perform one or more audio processing algorithms to perform noise cancellation or facilitate audio sampling from the user microphone(s) 144 and/or the ambient microphone(s) 146. Such algorithms may include adaptive filtering techniques to reduce background noise and isolate desired sound sources. Voice activity detection can be used to identify and extract speech segments from the audio stream. For example, the audio signal can be processed, for example by use of an inverse Fourier transform, from the frequency domain into a time-domain digital signal which can be analyzed to identify one or more voices in the given audio signal. Furthermore, beamforming techniques employing multiple microphones can enhance the directionality and signal-to-noise ratio of captured audio. In some implementations, the audio processing circuitry 148 can prioritize processing to isolate external voices, and in other implementations the audio processing circuitry 148 can prioritize processing to isolate the voice of the user of the earbud(s) 140.

Based on the above-described processing, the audio processing circuitry 148, can be configured to isolate a voice recording that primarily includes the user's voice and a reduced amount of audio related to the voices of other people at the location or other background noise. Such voice recording can be generated based on a recording via user microphone(s) 144 and/or processing of an ambient recording generated by ambient microphone(s) 146. Based on the voice recording, the earbud(s) 140, and particularly the audio processing circuitry 148 can generate a voice data that is to be transmitted to the companion device 110.

Similarly, based on the above-described processing, the audio processing circuitry 148, can be configured to generate an ambient recording that can include one or more sounds of the location of the user at the time of recording. Such sounds can include the voice of the user, the voice(s) of other people, background noise, etc. In some implementations, the audio processing circuitry 148 can generate audio data based on the audio recording, and then transmit the audio data to the companion device 110. In some implementations, prior to sending the audio data, the audio processing circuitry 148 can process the ambient recording to remove one or more background sounds.

In some implementations, the audio processing circuitry 148 can be configured to process the ambient recording and/or voice recording to isolate one or more voice(s) of other people in the ambient recording. The audio processing circuitry 148 can generate data related to the voice of another person, and transmit that data to the companion device 110.

In some implementations, various of the data (e.g., the ambient data, the voice data, and the data related to the voice of the other person) can be transmitted as part of a single data stream. For example, the data can be multiplexed together as described above. In other implementations, various of the data can be transmitted separately as described above.

In some implementations, the companion device 110 can include audio processing circuitry 136, that can be similar to audio processing circuitry 148. Specifically, the audio processing circuitry 136 can be configured to perform one or more of the operations or processes described above with respect to audio processing circuitry 136. For example, in some implementations the audio processing circuitry 136 can be configured to process one or both of the ambient data and/or the voice data to isolate the user's voice, remove background noise, isolate the voice of another person, etc.

Similarly, in some implementations, the NL based response system 120 include audio processing circuitry 118, that can be similar to audio processing circuitry 148. Specifically, the audio processing circuitry 118 can be configured to perform one or more of the operations or processes described above with respect to audio processing circuitry 148. For example, in some implementations the audio processing circuitry 118 can be configured to process one or both of the ambient data and/or the voice data to isolate the user's voice, remove background noise, isolate the voice of another person, etc.

It will be understood that the various processes or operations described above with respect to the audio processing circuitries 118/136/148 are intended as non-limiting examples of such processes. In other embodiments, the circuitries 118/136/148 can additionally or alternatively perform one or more audio processing techniques. Such processing can permit the separation and independent transmission of the user's voice and ambient sounds, enabling more precise analysis and contextual understanding by the conversational AI assistant.

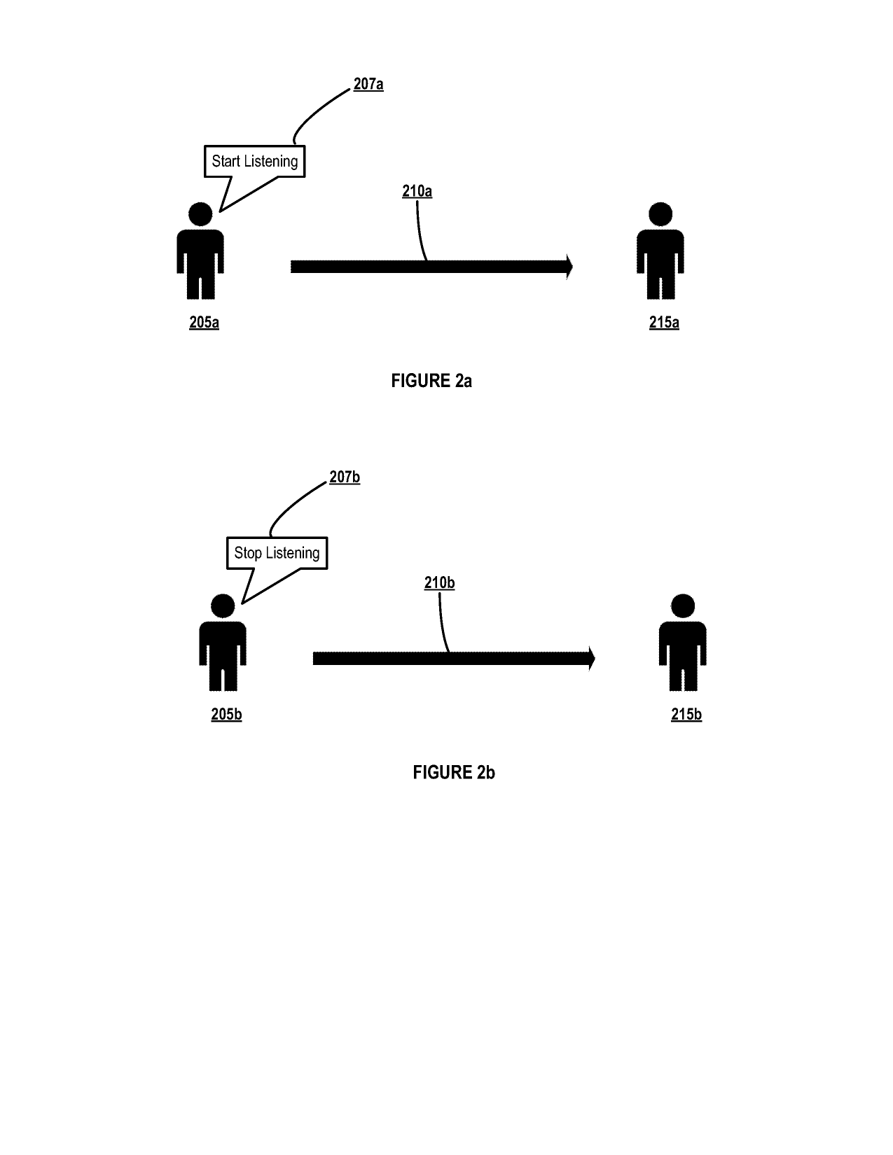

FIG. 2a depicts an example of how a recording session can be initiated. Specifically, a user 205a can speak a verbal cue at 207a. At 210a, the verbal cue can be processed, and the recording session can be initiated at 215a. As a non-limiting and specific example, the verbal cue 207a could be a phrase such as "start listening." The verbal cue could be picked up by one or more of the microphones 144 or 146 of the earbud(s) 140. The audio processing circuitry 148 could process the audio and transmit data related to the audio to the companion device 110. The user input engine 111, audio processing circuitry 118, and/or application(s) 115 (or some other circuitry of the companion device 110) could process the cue and identify that a recording session is to be started. A direction could then be provided by such circuitry or engine to the earbud(s) 140, which would then begin a voice and/or ambient recording as described above.

FIG. 2b depicts an example of how a recording session can be stopped. Specifically, a user 205b can speak a verbal cue at 207b. At 210b, the verbal cue can be processed, and the recording session can be stopped at 215b. As a non-limiting and specific example, the verbal cue 207b could be a phrase such as "stop listening." The verbal cue could be picked up by one or more of the microphones 144 or 146 of the earbud(s) 140. The audio processing circuitry 148 could process the audio and transmit data related to the audio to the companion device 110. The user input engine 111, audio processing circuitry 118, and/or application(s) 115 (or some other circuitry of the companion device 110) could process the cue and identify that a recording session is to be stopped. A direction could then be provided by such circuitry or engine to the earbud(s) 140, which would then stop a voice and/or ambient recording as described above.

In some implementations, either of the processes depicted in FIGS. 2a or 2b could be performed wholly by the companion device 110. For example, the companion device 110 could monitor for one or more of the cues 207a/207, and/or record the voice or ambient recording(s). However, having the earbud(s) 140 record the verbal cue and/or record the audio could be beneficial because the earbud(s) 140 could have a direct line of sight to various other audio sources (e.g., other people) in the room, while the companion device 110 could be in a pocket or backpack. Similarly, in some implementations, either of the processes depicted in FIGS. 2a or 2b could be performed wholly by the earbud(s) 140. In some implementations, the audio processing circuitry 136 could perform at least portions of the processes described with respect to FIGS. 2a or 2b.

In addition to stopping the audio session, the cue at 207a could cause the earbud(s) 140 to switch between different operating modes, such as from an Active Noise Cancellation (ANC) mode to a Transparency mode, also referred to as XPC (External Pass-Through) mode. In ANC mode, the earbud(s) 140 can actively reduce or eliminate external sounds, for example by processing sounds in real time and playing, to the user, an audio signal that is the inverse of the audio signal in the room. The two audio signals could effectively cancel each other, thereby causing the user to experience a reduced amount of audio from the location. By contrast, while in a transparency mode, the earbud(s) 140 could allow external sounds to be heard by the user or played through the speaker(s) 142, providing a more natural listening experience. For example, saying “start listening” at 207a might not only initiate audio recording but also instruct the earbuds to transition to transparency mode, enabling the user to clearly hear their surroundings while the earbuds simultaneously capture audio data. In some cases, the user may choose to disable transition from ANC to XPC during the live recording sessions.

Conversely, when the verbal cue 207b is given, the companion software application (e.g., as may be running at 115 on the companion device 110) can instruct the earbud(s) 140 to transition from transparency mode back to ANC mode. This shift in mode can cause the earbud(s) 140 to effectively block external noises (e.g., by playing a sound wave that is the inverse of the sound wave reaching the user in real-time or near real-time), allowing the user to return to an environment of relative quiet and focus now that the recording session has concluded and external input is no longer prioritized.

It will be understood that the specific examples given with respect to FIGS. 2a and 2b are intended as non-limiting examples. For example, the specific verbal cue or phrase given at one or both of 207a/207b can be different in different implementations. In some implementations, the triggering event to start/end the mode transition or recording session can be a different type of cue such as activating a button or switch on the companion device 110 or earbud(s) 140, activating an application on the companion device 110, etc.

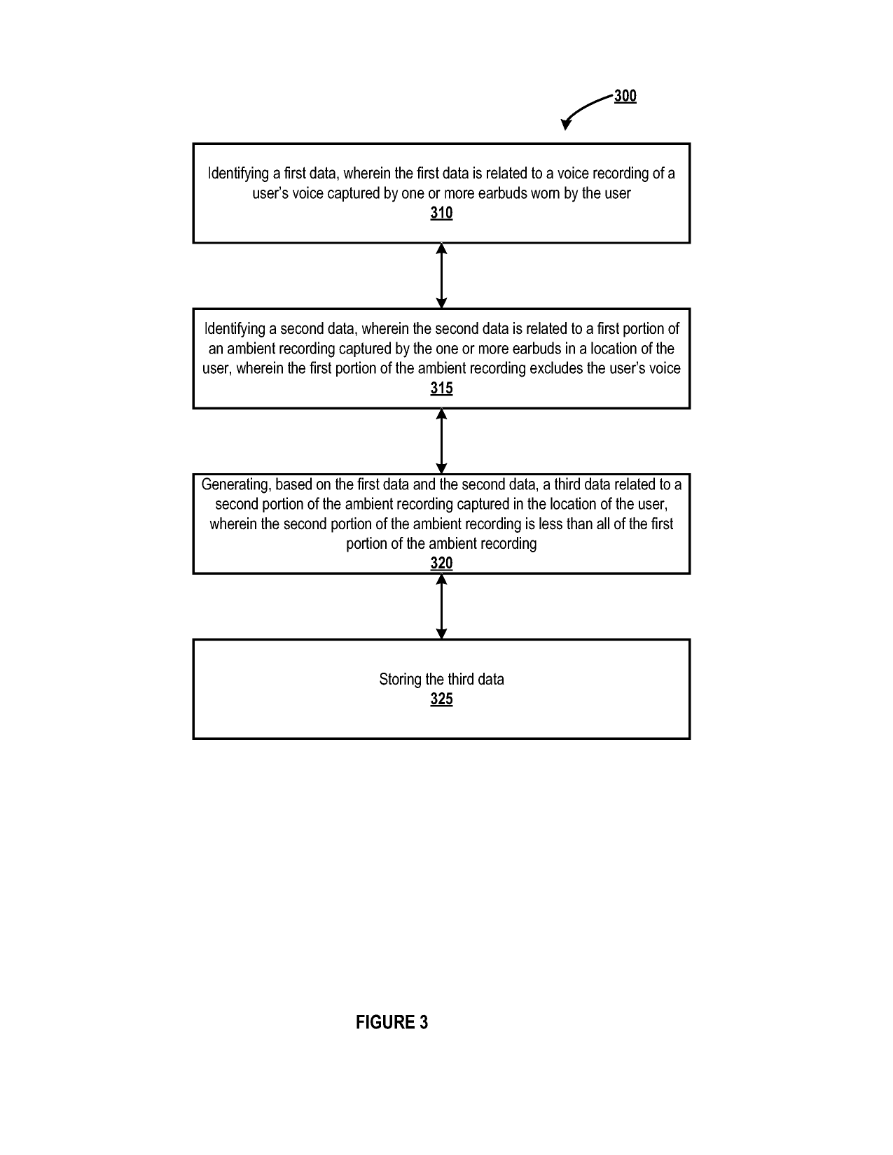

FIG. 3 depicts an example process 300 related to isolation of a specific sound (e.g., the voice of another person) in an audio recording as described above. Some or all of the process 300 can be performed by one or both of a companion device such as companion device 110 and one or more earbuds such as earbud(s) 140. In the specific implementation of FIG. 3, the process 300 can be performed by audio processing circuitry 118 of the companion device 110. At block 305, the process 300 can include identifying first data. The first data can be, for example, related to a voice recording of a user’s voice captured by one or more earbud(s) 140 worn by the user and transmitted to the companion device 110.

At block 310, the process 300 can include identifying second data. The second data can be related to a first portion of an ambient recording captured by the earbud(s) 140 in a location of the user and subsequently transmitted to the companion device 110. In some implementations, the first portion of the ambient recording can exclude the user’s voice. In other embodiments the first portion of the ambient recording could include the user's voice.

At block 315, the process 300 can include generating third data based on the first data and the second data. The third data can be related to a second portion of the ambient recording captured in the location of the user. In some implementations, the second portion of the ambient recording can be less than all of the first portion of the ambient recording. The generation of the third data can include generating, based on the second data, fourth data related to background audio at the location of the user. In some cases, the method can remove the fourth data from the second data to generate the third data. In some implementations, the third data can include or relate to the voice of another person that was speaking during the recording session related to the voice recording and/or ambient recording.

At block 320, the system can store the third data in a storage device such as storage device 116 and/or storage device 138.

In some implementations, the first data can be based on performing a first inverse Fourier transform on the voice recording, and identifying the first data based on a result of the first inverse Fourier transform. As described in dependent operations, generating the second data can be based on performing a second inverse Fourier transform on the ambient recording to generate an intermediate data, and removing the first data from the intermediate data.

The first data can be received from the earbud(s) 140 in a first data stream and the second data can be received from the earbud(s) 140 in a second data stream. In other implementations, the data stream related to the ambient recording can be identified from the earbud(s) 140, then the first data and the second data can be generated based on the data stream.

The voice recording and the ambient recording can be recorded by the earbud(s) 140 based on a verbal cue provided by the user. The verbal cue can be processed by the earbud(s) 140 or the processors of the electronic device 110. The earbud(s) 140 can communicate wirelessly with the electronic device 110.

In some implementations, the first data can include a textual description related to the voice recording, or the second data can include a textual description related to the first portion of the ambient recording. The third data can be transmitted to a second electronic device configured to process the third data using a generative model.

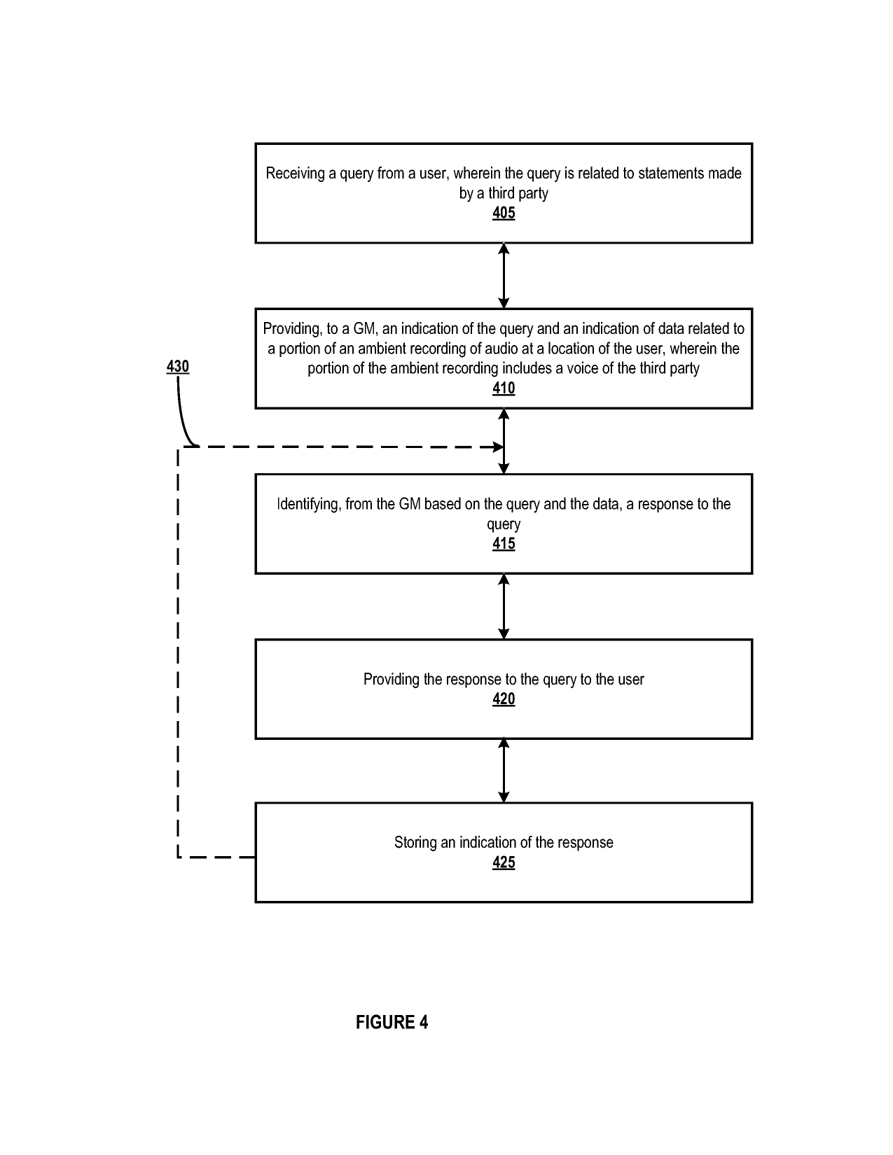

FIG. 4 depicts an alternative example process 400 related to processing of a NL query from a user related to a recording of a voice of another person, in accordance with various implementations. In some implementations, the process 400 can be performed by, for example, the NL based response system 120 of FIG. 1.

At block 405, the process 400 can include receiving, from the user, a query. The query can relate to statements that were made by a third party.

At block 410, the process 400 can include providing, to a GM, an indication of the query and an indication of data related to a portion of an ambient recording of audio at a location of the user. The portion of the ambient recording can include a voice of the third party. The system can then access the data related to the ambient recording that was stored in a storage device such as storage device 116 and/or storage device 138. In some implementations, the query can be further based on an audio recording of the voice of the user. In some implementations, the audio recording of the voice of the user can be based on the ambient recording.

At block 415, the process 400 can include identifying, from the GM based on the query and the data, a response to the query. The ambient recording can be related to a recording session, and the response to the query may be further based on a prior query from the user that was related to the same recording session. In some implementations, the query can be related to a first query session, and the prior query can be related to a prior query session that is different from the first query session.

At block 420, the process 400 can include providing the response to the query to the user. In providing the response, the rendering engine 112 can provide content for audible or visual presentation to a user of the companion device 110 using one or more output devices 114.

At block 425, the process 400 can include storing the indication of the response. This can allow a future query session with the user, which would allow the AI model to build more context as to the recording that was previously made. For example, at 435, the process 400 can iterate to repeat elements 415, 420, and 425 in a new query session where a previous query session is used as context.

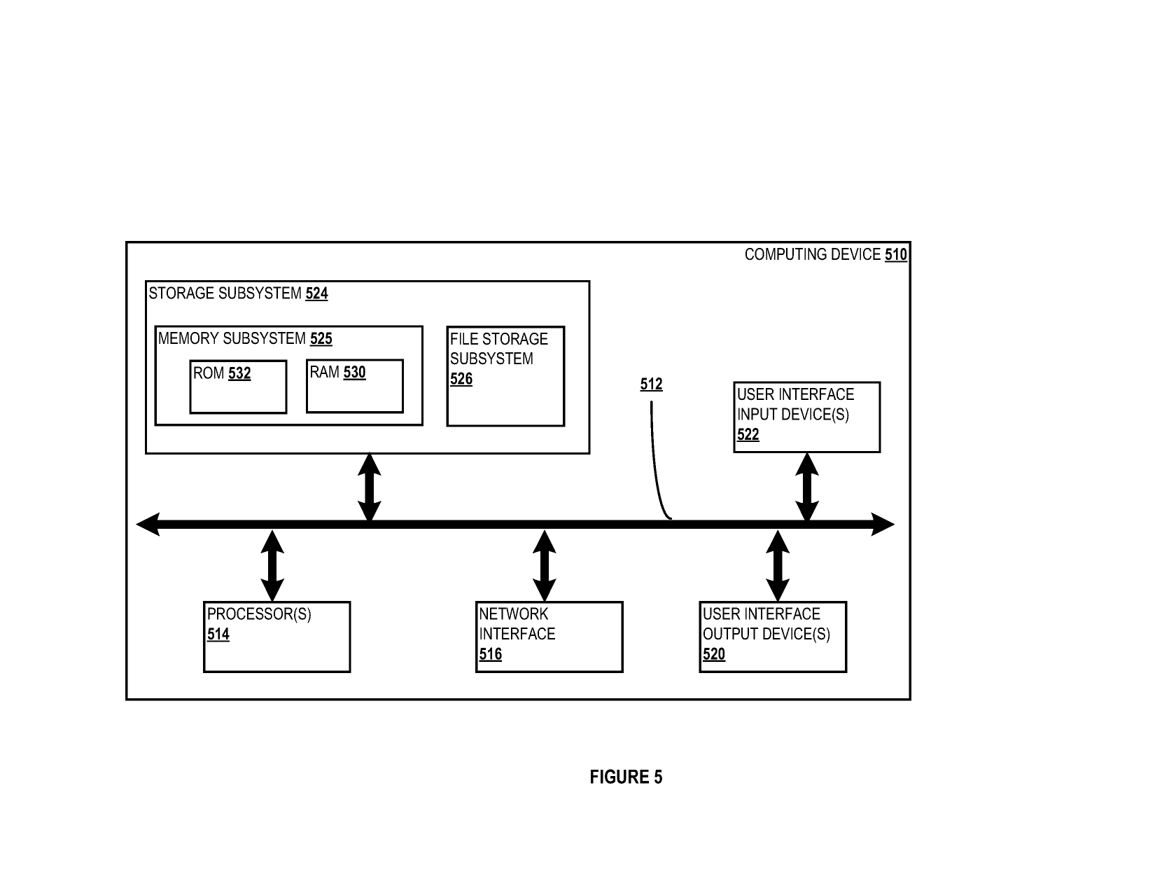

Turning now to FIG. 5, a block diagram of an example computing device 510 that can optionally be utilized to perform one or more aspects of techniques described herein is depicted. In some implementations, one or more of a companion device, cloud-based automated assistant component(s), and/or other component(s) can include one or more components of the example computing device 510. The computing device 510 can be used to implement, for example, the companion device 110 of FIG. 1. In some implementations, the computing device 510 can additionally or alternatively be used to implement the NL based response system 120, the VLM(s) 150, and/or the further application(s) 160.

Computing device 510 can include at least one processor 514, which can communicate with a number of peripheral devices via bus subsystem 512. These peripheral devices can include, for example, a storage subsystem 524. The storage subsystem can include, for example, one or more of a memory subsystem 525, a file storage subsystem 526, a user interface output device 520, a user interface input device 522, and a network interface subsystem 516. The input and output devices 520 and 522 can allow user interaction with computing device 510 and can be part of or otherwise related to user input engine 111 and/or output device(s) 114. Network interface subsystem 516 can provide an interface to outside networks, and can be coupled to corresponding interface devices in other computing devices.

User interface input devices 522 can include, for example, one or more of a keyboard, pointing devices such as a mouse, trackball, touchpad, or graphics tablet, a scanner, a touch screen incorporated into the display, audio input devices such as voice recognition systems, microphones, and/or other types of input devices. In general, use of the term "input device" is intended to include all possible types of devices and ways to input information into computing device 510 or onto a communication network.

User interface output devices 520 can include, for example, a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can additionally or alternatively provide non-visual display such as via audio output devices. In general, use of the term "output device" is intended to include all possible types of devices and ways to output information from computing device 510 to the user and/or to another machine or computing device.

Storage subsystem 524 can store programming and data constructs that provide the functionality of some, or all, of the modules described herein. For example, the storage subsystem 524 can include the logic to perform selected aspects of the methods disclosed herein, as well as to implement various components such as those depicted in FIG. 1.

Software programs or modules (e.g., the multi-modal model 208) of the computing device 510 can be executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 526 in the storage subsystem 524, or in other machines accessible by the processor(s) 514.

Bus subsystem 512 can provide a mechanism for letting the various components and subsystems of computing device 510 communicate with each other as intended. Although bus subsystem 512 is shown schematically as a single bus, alternative implementations of the bus subsystem 512 can use multiple buses.

Computing device 510 can be of varying types including a workstation, server, computing cluster, blade server, server farm, or some other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or can make use of personal and/or monitored information), the users can be provided with an opportunity to control whether programs or features collect user information (e.g., information about a user’s social network, social actions or activities, profession, a user’s preferences, or a user’s current geographic location), or to control whether and/or how to receive content from the content server that can be more relevant to the user. Also, certain data can be treated in one or more ways before it is stored or used, so that personal identifiable information is removed. For example, a user’s identity can be treated so that no personal identifiable information can be determined for the user, or a user’s geographic location can be generalized where geographic location information is obtained (such as to a city, ZIP code, or state level), so that a particular geographic location of a user cannot be determined. Thus, the user can have control over how information is collected about the user and/or used.

In situations in which the systems described herein collect personal information about users (or as often referred to herein, “participants”), or can make use of personal information, the users can be provided with an opportunity to control whether programs or features collect user information (e.g., information about a user’s social network, social actions or activities, profession, a user’s preferences, or a user’s current geographic location), or to control whether and/or how to receive content from the content server that can be more relevant to the user. Also, certain data can be treated in one or more ways before it is stored or used, so that personal identifiable information is removed. For example, a user’s identity can be treated so that no personal identifiable information can be determined for the user, or a user’s geographic location can be generalized where geographic location information is obtained (such as to a city, ZIP code, or state level), so that a particular geographic location of a user cannot be determined. Thus, the user can have control over how information is collected about the user and/or used.

In some implementations, a method implemented by processor(s) is provided and includes identifying a first data. The first data is related to a voice recording of a user's voice that one or more earbuds worn by the user captured. The method includes identifying a second data. The second data is related to a first portion of an ambient recording that one or more earbuds captured in a location of the user. The first portion of the ambient recording excludes the user's voice. The method also includes generating, based on the first data and the second data, a third data. The third data is related to a second portion of the ambient recording that was captured in the location of the user. The second portion of the ambient recording is less than all of the first portion of the ambient recording. The method also includes storing the third data.

In some implementations, the first data is based on performing a first inverse Fourier transform on the voice recording and identifying the first data based on a result of the first inverse Fourier transform.

In some of those implementations, generating the second data can be based on performing a second inverse Fourier transform on the ambient recording to generate an intermediate data, and removing the first data from the intermediate data.

In some versions of those implementations, generating the third data can include generating, based on the second data, fourth data related to background audio at the location of the user, and removing the fourth data from the second data to generate the third data.

In some implementations, the third data is related to a voice of another person captured by one or more of the earbuds in the location of the user.

In some implementations, the first data is received from the one or more earbuds in a first data stream and the second data is received from the one or more earbuds in a second data stream.

In some implementations, the method can further include identifying, from the earbud, a data stream related to the ambient recording; generating, based on the data stream, the first data; and generating, based on the data stream, the second data.

In some implementations, the voice recording and the ambient recording are recorded by the one or more earbuds based on a verbal cue provided by the user.

In some versions of those implementations, the verbal cue is processed by the one or more earbuds.

In some versions of those implementations, the verbal cue is processed by the one or more processors of the electronic device.

In some implementations, the one or more earbuds are in wireless communication with the electronic device.

In some implementations, the first data includes the voice recording.

In some implementations, the second data includes the first portion of the ambient recording.

In some versions of those implementations, the first data can include a textual description related to the voice recording or the second data can include a textual description related to the first portion of the ambient recording.

In some implementations, the method can further include transmitting the third data to a second electronic device, wherein the second electronic device can be configured to process the third data using a generative model.

In some implementations, a method implemented by processor(s) is provided and includes receiving a query from a user. The query is related to statements made by a third party. The method includes providing, to a GM, an indication of the query and an indication of data related to a portion of an ambient recording of audio at a location of the user. The portion of the ambient recording includes a voice of the third party. The method also includes identifying, from the GM based on the query and the data, a response to the query. The method includes providing the response to the query to the user and storing the indication of the response. In some implementations, the response to the query is further based on an audio recording of a voice of the user. In some of those implementations, the audio recording of the voice of the user is based on the ambient recording. In some implementations, the ambient recording is related to a recording session, and the response to the query is further based on a prior query from the user that is related to the same recording session. In some of those implementations, the query is related to a first query session and the prior query is related to a prior query session that is different than the first query session.

In some implementations, the response to the query can optionally be based on an audio recording of a voice of the user.

In some of those implementations, the audio recording of the voice of the user can optionally be based on the ambient recording.

In some implementations, the ambient recording can optionally be related to a recording session, and the response to the query can optionally be further based on a prior query from the user that is related to the same recording session.

In some of those implementations, the query can optionally be related to a first query session, and the prior query can optionally be related to a prior query session that can optionally be different than the first query session.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform operations of any of the aforementioned methods. Some implementations also include a computer program product including instructions executable by one or more processors to perform operations of any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented using one or more processors of an electronic device, the method comprising:
identifying a first data, wherein the first data is related to a voice recording of a user’s voice captured by one or more earbuds worn by the user;
identifying a second data, wherein the second data is related to a first portion of an ambient recording captured by the one or more earbuds in a location of the user, wherein the first portion of the ambient recording excludes the user’s voice;
generating, based on the first data and the second data, a third data related to a second portion of the ambient recording captured in the location of the user, wherein the second portion of the ambient recording is less than all of the first portion of the ambient recording; and
storing the third data.

2. The method of claim 1, wherein the first data is based on:
performing a first inverse Fourier transform on the voice recording; and
identifying the first data based on a result of the first inverse Fourier transform.

3. The method of claim 2, wherein generating the second data is based on:
performing a second inverse Fourier transform on the ambient recording to generate an intermediate data; and
removing the first data from the intermediate data.

4. The method of claim 1, wherein generating the third data includes:
generating, based on the second data, fourth data related to background audio at the location of the user; and
removing the fourth data from the second data to generate the third data.

5. The method of claim 1, wherein the third data is related to a voice of another person captured by one or more of the earbuds in the location of the user.

6. The method of claim 1, wherein the first data is received from the one or more earbuds in a first data stream and the second data is received from the one or more earbuds in a second data stream.

7. The method of claim 1, wherein the method further comprises:
identifying, from the earbud, a data stream related to the ambient recording;
generating, based on the data stream, the first data; and
generating, based on the data stream, the second data.

8. The method of claim 1, wherein the voice recording and the ambient recording are recorded by the one or more earbuds based on a verbal cue provided by the user.

9. The method of claim 8, wherein the verbal cue is processed by the one or more earbuds.

10. The method of claim 8, the verbal cue is processed by the one or more processors of the electronic device.

11. The method of claim 1, wherein the one or more earbuds are in wireless communication with the electronic device.

12. The method of claim 1, wherein the first data comprises the voice recording.

13. The method of claim 1, wherein the second data comprises the first portion of the ambient recording.

14. The method of claim 1, wherein:
the first data includes a textual description related to the voice recording; or
the second data includes a textual description related to the first portion of the ambient recording.

15. The method of claim 1, wherein the method further comprises transmitting the third data to a second electronic device, wherein the second electronic device is configured to process the third data using a generative model.

16. One or more non-transitory computer-readable media comprising instructions that, upon execution of the instructions by one or more processors of an electronic device, are to cause the electronic device to:
identify a first data, wherein the first data is related to a voice recording of a user’s voice captured by one or more earbuds worn by the user;
identify a second data, wherein the second data is related to a first portion of an ambient recording captured by the one or more earbuds in a location of the user, wherein the first portion of the ambient recording excludes the user’s voice;
generate, based on the first data and the second data, a third data related to a second portion of the ambient recording captured in the location of the user, wherein the second portion of the ambient recording is less than all of the first portion of the ambient recording; and
store the third data.

17. The one or more non-transitory computer-readable media of claim 16, wherein generation of the third data includes:
generating, based on the second data, fourth data related to background audio at the location of the user; and
removing the fourth data from the second data to generate the third data.

18. The one or more non-transitory computer-readable media of claim 16, wherein the third data is related to a voice of another person captured by one or more of the earbuds in the location of the user.

19. An electronic device comprising:
memory to store a first data, wherein the first data is related to a voice recording of a user’s voice captured by one or more earbuds worn by the user; and
one or more processors configured to:
identify a second data, wherein the second data is related to a first portion of an ambient recording captured by the one or more earbuds in a location of the user, wherein the first portion of the ambient recording excludes the user’s voice;
generate, based on the first data and the second data, a third data related to a second portion of the ambient recording captured in the location of the user, wherein the second portion of the ambient recording is less than all of the first portion of the ambient recording; and
store the third data.

20. The electronic device of claim 19, wherein generation of the third data includes:
generating, based on the second data, fourth data related to background audio at the location of the user; and
removing the fourth data from the second data to generate the third data.
